(19) United States
(12) Patent Application Publication
(10) Pub. No.: US 2023/0179487 A1
(43) Pub. Date: Jun. 8, 2023

(54) SYSTEMS AND METHODS FOR GENERATING CUSTOM INTERNET EMULATION ENVIRONMENTS

(71) Applicant: Joseph David Taylor, Seguin, TX (US)

(72) Inventor: Joseph David Taylor, Seguin, TX (US)

(21) Appl. No.: 18/077,950

(22) Filed: Dec. 8, 2022

Related U.S. Application Data
(60) Provisional application No. 63/287,229, filed on Dec. 8, 2021.

(51) Int. Cl. H04L 41/14; H04L 41/122; G06F 9/455

(52) U.S. Cl. CPC H04L 41/145; H04L 41/122; G06F 9/45558; G06F 2009/45595

(57) ABSTRACT

The present disclosure is for systems and methods for generating custom internet emulation environments. User specified custom configuration criteria are obtained and processed to generate virtual networking components in accordance with the configuration criteria. The virtual networking components are connected and assigned behavior characteristics that closely resemble internet performance of the custom configuration criteria. Virtual connection points are generated to allow a user to interface with the internet emulation environment in order to execute desired testing.

### CROSS-REFERENCE TO RELATED APPLICATIONS

This application claims the benefit of U.S. Provisional Application 63/287,229, filed Dec. 8, 2021, titled “INTERNET EMULATION SYSTEMS AND METHODS” which is herein incorporated by reference in its entirety.

### BACKGROUND

Software developers are faced with uncertainty regarding software performance when applications include internet interactions. For example, cloud based applications requiring communication between a server and client may perform differently depending on the relative locations of the server and client. Furthermore, the network configurations of the local environments around the server and client and the network configuration of intermediate connection pathways associated with the internet may affect performance.

Current internet simulation approaches oversimplify true internet architecture, essentially treating the internet as a set of switches which can be turned on and off to connect starting and destination locations, in essence in direct communication. Such approaches to internet simulation do not accurately reflect the complexity of connections across the internet nor accurately address behavior of internet communications. In general, applications tested locally with direct connection can result in communication that occurs much more quickly and reliably than real world environments. For example, real world scenarios have varying complexities and include aspects such as multipathing and dropped packets, among other issues which often are not reflected in direct communication laboratory testing simulations. Moreover, there is no singular configuration of a virtual testing environment which would be suitable for all testing scenarios (i.e. there is no one size fits all solution). Ultimately, there is a need for improved internet behavior emulation that will allow developers to more accurately test software under circumstances more closely resembling real world internet environments and to established preferred environments best suited to testing their particular applications or systems.

### SUMMARY

The present invention provides systems and methods for generating custom virtual networking configuration which emulate real world internet behavior. A series of configuration inputs are obtained from a user indicating the parameters of the internet configuration to be emulated. Exemplary parameters may include, but are not limited to, networking infrastructure to be emulated, internet service providers (ISP) to be emulated including the total number of ISPs to be emulated, the emulation size of each ISP (e.g. number of routers to be emulated), the geographic region or location of each ISP, routing operating system(s) (OS) to be emulated, routing protocols to be emulated, and connection points where a user would like to connect a test device(s) and/or system(s) under test to the emulated internet environment. The process of generating the virtual internet environment comprises applying data transport and routing aspects typical of the real world internet behavior such as packet loss and latency associated with the various pathways resulting from generating the virtual environment based on the configuration parameters thereby resulting in an internet emulation environment that closely resembles actual internet behavior. A user is then enabled to connect at least one test device and at least one system under test to the emulated internet environment in order to test performance under circumstances similar to that of the real-world internet, thereby enabling users to identify issues and/or improve performance prior to deploying applications in a live real-world environment which is something conventional systems fail to accurately provide.

Accordingly, some embodiments may provide multiple technological advantages over prior art systems. In addition, various embodiments may provide improvements in computing technology and technological features, for instance, by providing a system operable to generate and connect a plurality of virtual devices in a manner that closely resembles the true behavior of the internet with multipathing, packet loss, latency and the like, as opposed to simulating the internet as a set of switches which simple turn on and off to establish connections with minimal erroneous behavior. One non-limiting example of a technological advantage may include providing an improved user experience for users attempting to test software applications in an environment which closely emulates the real world prior to deploying the applications for live use and only then discovering issues. Another non-limiting example of a technological advantage may include providing a platform for testing a plurality of different emulation configurations in a timely manner by making adjustments to the configuration criteria and quickly and easily obtaining a new emulation environment in which they can test applications under different scenarios.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a system for generating custom internet emulation environments in accordance with an exemplary embodiment of the invention.

FIG. 2 illustrates a system for generating custom internet emulation environments in accordance with an exemplary embodiment of the present invention.

FIG. 3 illustrates an exemplary process for generating custom internet emulation environments according to one embodiment of the invention.

FIG. 4 illustrates one embodiment of the computing architecture that supports an embodiment of the inventive disclosure.

FIG. 5 illustrates components of a system architecture that supports an embodiment of the inventive disclosure.

FIG. 6 illustrates components of a computing device that supports an embodiment of the inventive disclosure.

FIG. 7 illustrates components of a computing device that supports an embodiment of the inventive disclosure.

### DETAILED DESCRIPTION

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

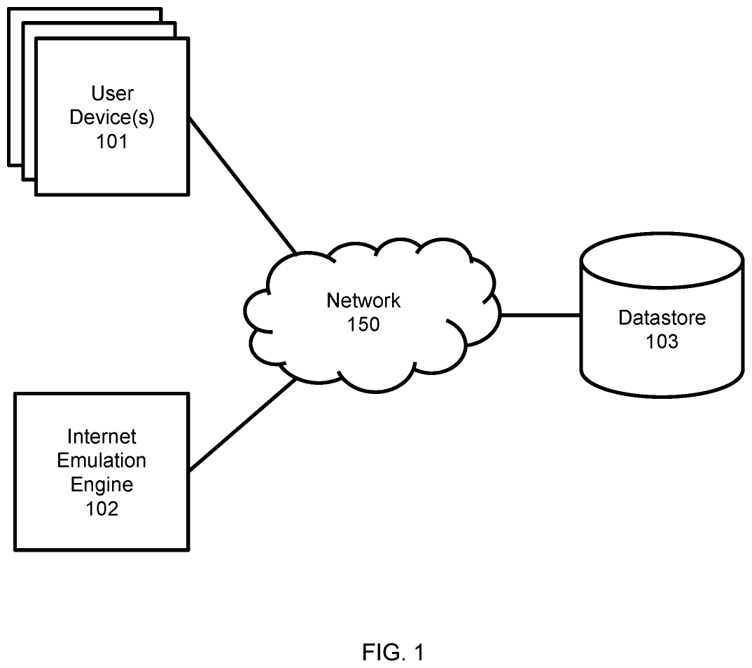

FIG. 1 illustrates an exemplary embodiment of a system for generating custom internet emulation environments according to one embodiment. The system includes user device(s) 101, internet emulation engine 102, datastore 103, and a network 150 over which the various systems communicate and interact. The various components described herein are exemplary and for illustration purposes only and any combination or subcombination of the various components may be used as would be apparent to one of ordinary skill in the art. The system may be reorganized or consolidated, as understood by a person of ordinary skill in the art, to perform the same tasks on one or more other servers or computing devices without departing from the scope of the invention.

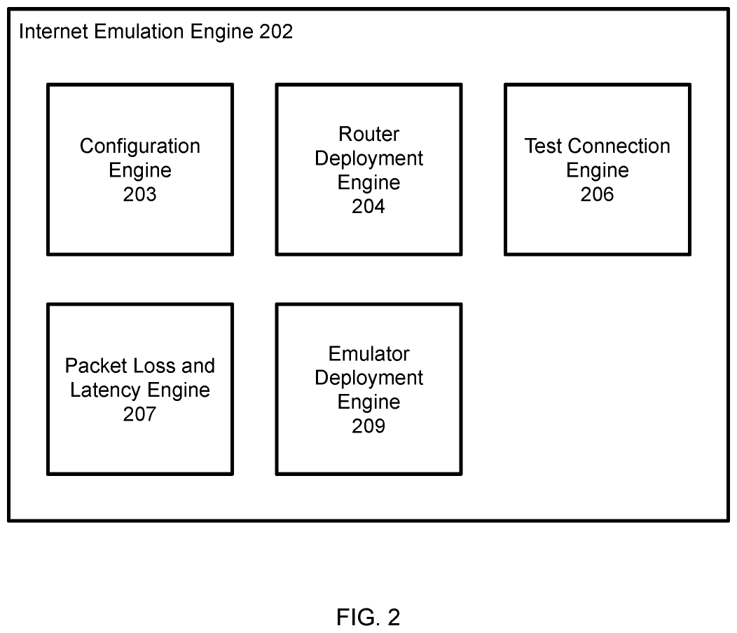

Internet emulation engine 102 receives configuration settings from user device(s) 101 and/or datastore 103 and creates and deploys an emulated internet environment in accordance with the configuration settings. Internet emulation engine 102 may be a server or cloud-based application or may be installed and executed on user device(s) 101. After creating an emulated internet environment, internet emulation engine 102 may transmit the emulated environment to user device(s) for review and/or storage in datastore 103 for later retrieval and review. In one embodiment, internet emulation engine 102 may also communicate configuration settings to datastore 103 for later retrieval, redeployment and/or modification. Internet emulation engine 102 is described in more detail in association with FIG. 2.

Datastore 103 serves to save configuration settings and internet emulation results. Data store 103 may be a separate component as depicted in FIG. 1. In one embodiment, datastore 103 may be incorporated into internet emulation engine 102 and/or user device(s) as opposed to a separate stand alone component without differing from the scope of the invention.

User device(s) 101 are used to communicate with internet emulation engine 102 and datastore 103 via network 150. User device(s) 101 may be used to provide configuration settings to the internet emulation engine 102, access saved configuration settings from datastore 103 and receive deployed internet emulations according to the configuration settings. User device(s) 101 include, generally, a computer or computing device including functionality for communicating (e.g., remotely) over a network 150. Data may be collected from user devices 101, and data requests may be initiated from each user device 101. User device(s) 101 may be a server, a desktop computer, a laptop computer, personal digital assistant (PDA), an in- or out-of-car navigation system, a smart phone or other cellular or mobile phone, or mobile gaming device, among other suitable computing devices. User devices 101 may execute one or more applications, such as a web browser (e.g., Microsoft Windows Internet Explorer, Mozilla Firefox, Apple Safari, Google Chrome, and Opera, etc.), or a dedicated application to submit user data, or to make prediction queries over a network 150.

In particular embodiments, each user device 101 may be an electronic device including hardware, software, or embedded logic components or a combination of two or more such components and capable of carrying out the appropriate functions implemented or supported by the user device 101. For example and without limitation, a user device 101 may be a desktop computer system, a notebook computer system, a netbook computer system, a handheld electronic device, or a mobile telephone. The present disclosure contemplates any user device 101. A user device 101 may enable a network user at the user device 101 to access network 150. A user device 101 may enable its user to communicate with other users at other user devices 101.

A user device 101 may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user device 101 may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the user device 101 one or more Hyper Text Markup Language (HTML) files responsive to the HTTP request. The user device 101 may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The user device 101 may also include an application that is loaded onto the user device 101. The application obtains data from the network 150 and displays it to the user within the application 533 interface.

Exemplary user devices are illustrated in some of the subsequent figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

Network cloud 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 421 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to user devices or other devices in response to HTTP or other requests from user devices or other devices. A mail server is generally capable of providing electronic mail services to various user devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiment, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

FIG. 2 illustrates an exemplary internet emulation engine 202 according to one embodiment of the invention. The internet emulation engine 202 comprises a configuration engine 203, router deployment engine 204, private/public addressing assessment engine 206, packet loss and latency engine 207, and emulator deployment engine 209. The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met.

Configuration engine 203 obtains and/or provides emulation settings for use in building a custom emulated internet environment. The settings may be obtained via one or more user device(s). The settings may be obtained in the form of a user provided configuration file and/or via user input, such as via a web graphical user interface. At least one setting may be based on a default setting and/or a default configuration file. The settings may be used to populate a configuration file for later processing. The settings may include at least one of starting and destination locations (i.e. client and server locations), major internet service providers (ISPs) involved (i.e. continental ISPs), starting and destination internet protocol (IP) addresses, size of the ISP (e.g. number of routers per ISP to emulate), number of private to public transitions, number of public to private transitions, starting and destination connection interface (e.g. residential, small business network, medium business network, enterprise business network, business layer 2 (L2) tunnel, business private virtual routing and forwarding (VRF), datacenter, other ISP) and bandwidth settings. Each configuration can be saved for later retrieval and redeployment/testing.

Router deployment engine 204 generates an internet emulation environment comprised of virtual networking infrastructure based on information from the configuration engine 203. The virtual infrastructure may comprise virtual devices including, but not limited to, virtual machines and containers. Router deployment engine 204 may install a router operating system (OS) on each virtual device thereby generating a plurality of virtual routing or networking components. In one aspect, routing deployment engine 204 generates a plurality of routing pathways as a result of interconnecting the plurality of virtual devices. In one aspect, the router deployment engine 204 generates one or more virtual routers, access points, and/or wide area network (WAN) emulators according to the configuration settings in such a way as to closely emulate a real world internet environment. In one aspect, the router deployment engine 204 generates a plurality of virtual routing components based on the configuration settings described above, then uses at least one routing protocol to establish a plurality of potential routing pathways. In one aspect router deployment engine 204 may consume (e.g. read and process) a configuration file, such as that generated or populated by configuration engine 203, using information technology (IT) automation software, such as ANSIBLE, to generate the virtual routing components. Other IT automation software may be used without departing from the scope of the invention to at least one of configure systems, deploy software, and orchestrate workflows to generate an internet emulation environment. In one aspect, router deployment engine 204 establishes private to public and/or public to private IP address switches as part of establishing the internet emulation environment.

Test connection engine 206 is operable to generate virtual connection points for connecting at least one of test devices and systems to be tested (also referred to as systems under test). Test configuration engine 206 may generate at least one virtual connection point for connecting a system under test and at least one virtual connection point for connecting a test device. In one aspect, the virtual connection points comprise end points (at ends of routing pathways) representing desired testing locations of the test device(s) and system(s) under test. Exemplary test devices include but are not limited to end user devices such as those described above with respect to FIG. 1. Exemplary systems under test include but are not limited to software applications running on at least one of a local server(s) or cloud based server(s).

Packet loss and latency engine 207 is operable to determine at least one of packet loss and latency metrics for each of a plurality of routing pathways established by router deployment engine 204. In one aspect, packet loss and latency engine 207 is operable to determine the number of router hops associated with each routing pathway and use this information in determining an associated packet loss and/or latency metric for each pathway, such as by applying a fixed amount for each router hop. Depending on the configuration settings, there may be unique configurations of different system administration/deployment options, with varying emulated routers, access, aggregation and core layer setups which influence packet loss and/or latency metrics. For example, the virtual routing components may employ interior and/or exterior gateway protocols in order to identify potential routing pathways, evaluate most likely pathways, and/or the most efficient pathways, which in turn are used in latency and packet loss calculations. In one aspect, packet loss and latency engine 207 is operable to consider each virtual router involved in a given pathway in order to determine a unique latency and/or packet loss depending on the characteristics of each virtual router and its location. For example, in one embodiment, virtual routers deployed in the different access, aggregation and core layers may have different latencies and packet losses. In one embodiment, virtual routers located in one major ISP may have the same or different latencies and/or packet loss than virtual routers in another major ISP. In one aspect, packet loss and latency engine 207 is operable to use private to public and/or public to private IP address switches as a factor in determining the amount of packet loss and/or latency to apply to a given pathway.

In one aspect, packet loss may generally be on the order of 1%, however other amounts may be used depending on a given configuration. Other exemplary values may be on the order to 0.25-0.5% or values greater than 1% such as 1-5%. These are merely exemplary, and any amount of packet loss may be used based on the particular configuration being emulated. Packet loss may be applied as an overall total packet loss to be emulated between a given source and destination (e.g. first and second virtual connection points) or may be applied on a connection by connection basis such as applying some amount of packet loss at each virtual router hop, network interface, and/or IP address switch.

In one aspect, latency may be based on the major ISPs being emulated. For example, each major ISP may have their own unique latency for communications remaining within that given ISP. Similarly, the connections between each major ISP may also have a unique latency associated with that particular major ISP to major ISP connection. Latency may be applied as an overall total amount of latency, such as total milliseconds (ms) of delay, or may be applied on a connection by connection basis such as applying some amount of delay at each virtual router hop, network interface, or IP address switch.

Emulator deployment engine 209 is operable to provide the resulting custom internet emulation environment (virtual routing components and associated connection points) for use in testing. The emulated environment provides the ability for a user to test an application by testing communication using the emulated environment by transmitting and receiving information between the emulated starting and destination locations (e.g. test device and system under test) according to the established emulation criteria. In addition, the deployment engine may output a network diagram of the emulated environment and provide the ability to save this deployment and/or network diagram and/or edit the configuration in order to redeploy a new configuration. In one aspect, emulator deployment engine 209 connects user specified test device(s) and/or system(s) under test to the emulated environment. In one aspect, emulator deployment engine 209 generates and provides instructions indicating how to connect at least one of the test device(s) and system(s) under test to the virtual connection points.

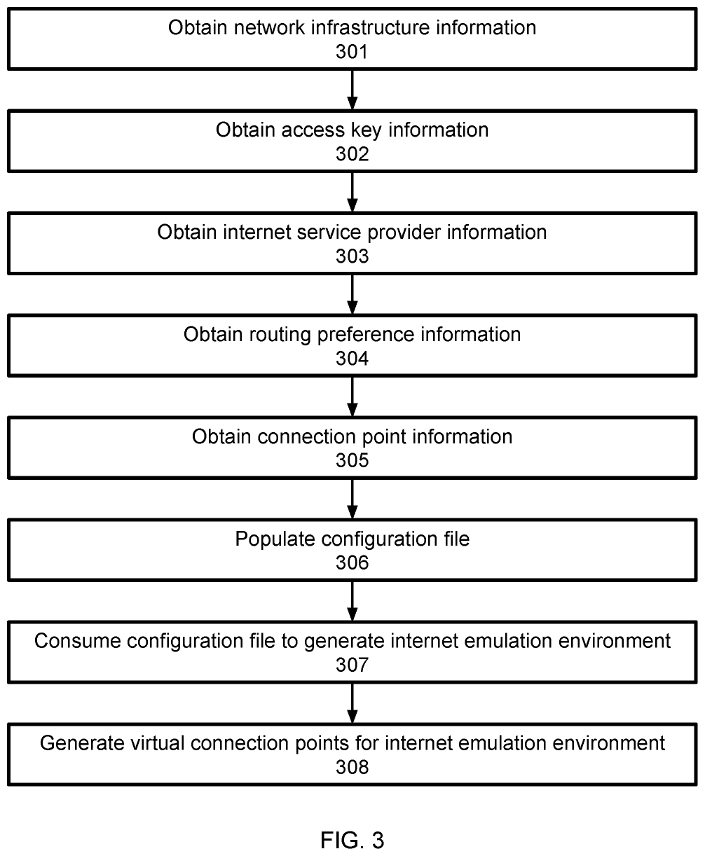

FIG. 3 illustrates an exemplary process for generating a custom virtualization environment for internet emulation according to one embodiment of the invention. The process comprises obtaining networking infrastructure information 301, obtaining access key information associated with the infrastructure information 302, obtaining internet service provider (ISP) information to be emulated 303, obtaining router operating system information to be emulated 304, obtaining connection point information 305, populating an emulation configuration file 306, consuming the emulation configuration to generate an internet emulation environment 307, generating a plurality of virtual connection points for connecting to the internet emulation environment 308. The process may comprise additional steps, fewer steps, and/or a different order of steps without departing from the scope of the invention as would be apparent to one of ordinary skill in the art.

At step 301, the process comprises obtaining networking infrastructure information. The networking infrastructure information may be user specified infrastructure information. In one aspect, the infrastructure information is obtained via a web graphical user interface. In one aspect, the infrastructure information is obtained via a user provided configuration file. Exemplary networking infrastructure information may include, but is not limited to, at least one of cloud infrastructure, AWS infrastructure, Azure infrastructure, VMware infrastructure, and bare metal infrastructure.

At step 302, the process comprises obtaining access key information associated with the infrastructure information. The access key information may be user specified access key information associated with the credentials (e.g. username and password) necessary to access the associated networking infrastructure of step 301. In one aspect, the access key information is obtained via a web graphical user interface. In one aspect, the access key information is obtained via a user provided configuration file.

At step 303, the process comprises obtaining internet service provider (ISP) information to be emulated. The ISP information may be user specified ISP information. In one aspect, the ISP information is obtained via a web graphical user interface. In one aspect, the ISP information is obtained via a user provided configuration file. ISP information may comprise at least one of a total number of ISPs, an emulation size for each ISP, and a region associated with each ISP. ISP information may additionally comprise at least one of major internet service providers (ISPs) involved (i.e. continental ISPs), starting and destination internet protocol (IP) addresses, a number of routers per ISP to emulate, number of private to public transitions, number of public to private transitions, starting and destination connection interface (e.g. residential, small business network, medium business network, enterprise business network, business layer 2 (L2) tunnel, business private virtual routing and forwarding (VRF), datacenter, other ISP) and bandwidth settings.

At step 304, the process comprises obtaining routing preference information to be emulated. The routing preference information may comprise at least one of data transfer preferences and routing preferences. The routing preference information may be user specified routing preference information. In one aspect, the routing preference information is obtained via a web graphical user interface. In one aspect, the routing preference information is obtained via a user provided configuration file. In one aspect, routing preference information comprises at least one of a router OS (or a plurality of router OSs) and a routing protocol (or plurality of routing protocols) to be emulated. Router OS information may comprise at least one of VyOS, JuniperVMX and Cisco. Routing protocols may comprise at least one of open shortest path first (OSPF), and external border gateway protocol (eBGP). These router OSs and routing protocols are merely exemplary and other router OSs and routing protocols may be used in the emulation process without departing from the scope of the invention.

At step 305, the process comprises obtaining connection point information. The connection point information may be user specified connection point information. In one aspect, the connection point information is obtained via a web graphical user interface. In one aspect, the connection point information is obtained via a user provided configuration file. Connection point information generally comprises connection points for connecting at least one test device and at least one system under test. In one aspect, connection points may comprise user-specified locations of test devices and/or systems under test intended to be evaluated using the internet emulation environment.

At step 306, the process comprises populating an emulation configuration file. In one aspect the emulation configuration file comprises a YAML file. In one aspect, populating the configuration file comprises writing at least a portion of the information obtained in steps 301 through 305 to a configuration file thereby generating the emulation configuration file. In one aspect, populating an emulation configuration file comprises updating a default configuration file with at least a portion of the information obtained in steps 301 through 305 to generate an emulation configuration file. In one aspect, populating an emulation configuration file comprises using the user provided configuration file (as in step 301-305) as the emulation configuration file. In one aspect, populating an emulation configuration file comprises replacing a default configuration file with the user provided configuration file.

At step 307, the process comprises consuming the emulation configuration file to generate an internet emulation environment. In one aspect, consuming the configuration file to generate an internet emulation environment comprises generating and connecting a plurality of virtual devices and applying routing preference information. In one aspect, the configuration file is consumed using ANSIBLE, TERRAFORM, or similar automation software. In one aspect, other IT automation software may be used to at least one of configure systems, deploy software, and orchestrate workflows to generate an internet emulation environment based on information contained in the configuration file. In one aspect, consuming the configuration file may comprise generating a plurality of virtual devices including, but not limited to, virtual machines, virtual machines with a router OS installed, and/or containers such as Open Container Initiative (OCI) containers. In one aspect, consuming the configuration file may comprise installing at least one router OS on one or more virtual devices including, but not limited to, VyOS, JuniperVMX and/or Cisco. In one aspect, consuming the configuration file may comprise applying at least one routing protocol, including but not limited to OSPF and/or eBGP to the virtual devices. In one aspect, generating the internet emulation environment comprises interconnecting the plurality of virtual devices such that a plurality of different pathways are established. In one aspect, generating the internet emulation environment comprises applying at least one of packet loss metrics and latency metrics to each pathway. In one aspect, applying at least one of packet loss metrics and latency metrics to each pathway comprises applying the packet loss metrics and latency metrics to each pathway as a whole (i.e. based on the entirety of the pathway). In one aspect, applying at least one of packet loss metrics and latency metrics to each pathway comprises applying the packet loss metrics and latency metrics to a plurality of sub-portions of each pathway (e.g. between each virtual device, between a plurality of virtual devices forming a pathway less than a full pathway from one end point to another, etc.).

At step 308, the process comprises generating a plurality of virtual connection points for connecting to the internet emulation environment. The virtual connection points may comprise at least one connection point for connecting at least one test device. The virtual connection points may comprise at least one connection point for connecting at least one system to be tested or system under test. In one aspect, generating the plurality of virtual connection points comprises generating a first virtual connection point at one end point of a pathway and generating a second virtual connection point at a different end point of the pathway, wherein the first and second virtual connection points are configured to connect with at least one of a test device and a system under test.

The process may further comprise various steps including but not limited to the following. In one aspect, the process further comprises providing the internet emulation environment for use by at least one user to execute desired testing. In one aspect, the process further comprises connecting at least one of a test device and system under test to the internet emulation environment in order to establish the necessary connections for executing desired testing. In one aspect, the process further comprises providing instructions for connecting at least one of a test device and a system under test to the internet emulation environment so that desired testing can be executed.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

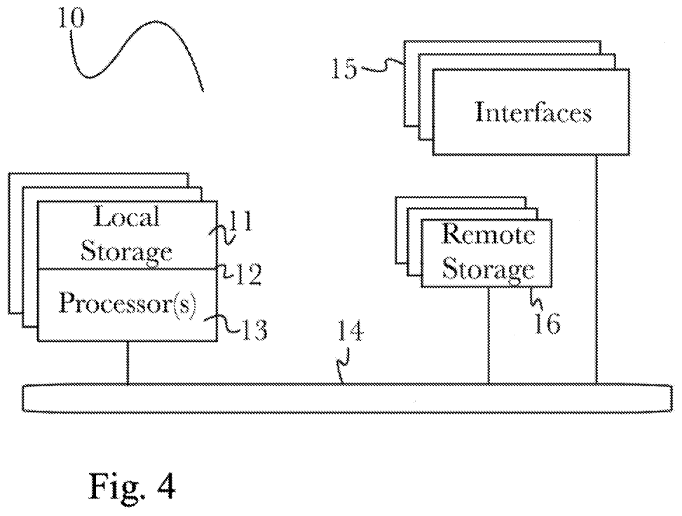

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given engine of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments). Any of the above mentioned systems, units, modules, engines, controllers, components or the like may be and/or comprise hardware and/or software as described herein. For example, the internet emulation engine 202 and subcomponents thereof may be and/or comprise computing hardware and/or software as described herein in association with FIGS. 4-7. Furthermore, any of the above mentioned systems, units, modules, engines, controllers, components, interfaces or the like may use and/or comprise an application programming interface (API) for communicating with other systems units, modules, engines, controllers, components, interfaces or the like for obtaining and/or providing data or information.

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

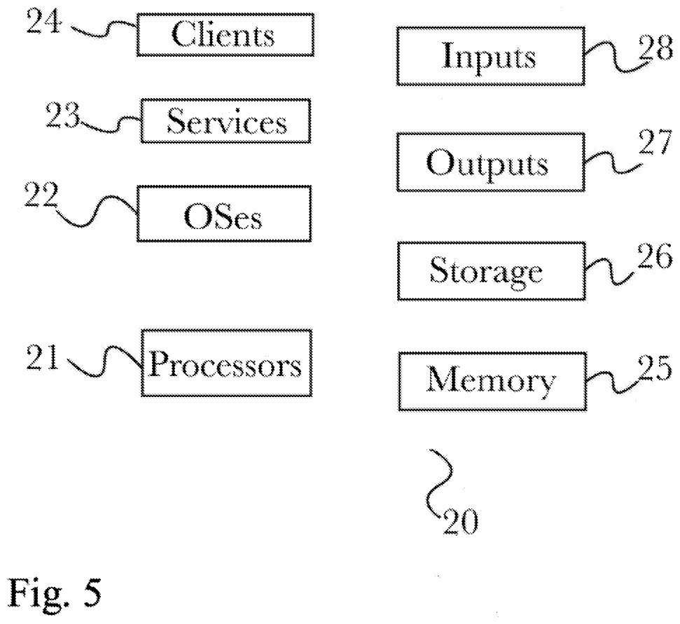

In some embodiments, systems may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

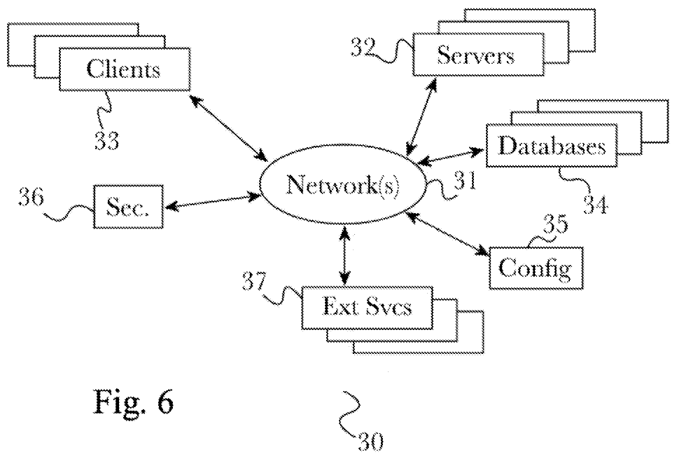

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

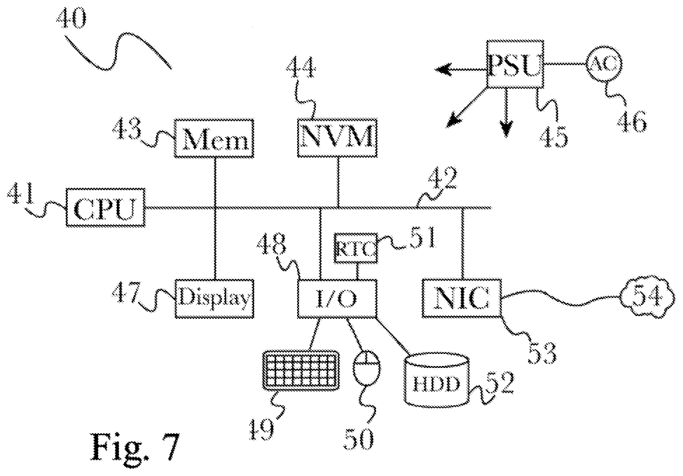

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computer implemented method for modeling and emulating network performance and generating a custom virtualization environment, the computer implemented method comprising:
obtaining user specified networking infrastructure information for use in an internet emulation environment;
obtaining user specified access key information associated with the infrastructure information;
obtaining user specified internet service provider (ISP) information to be emulated, the ISP information comprising a total number of ISPs, an emulation size for each ISP, and a region associated with each ISP;
obtaining user specified routing preference information, the routing preference information comprising at least one of at least one router operating system (OS) to be emulated and at least one routing protocol to be emulated;
obtaining user specified connection points, the connection points associated with a desired testing scenario;
populating an emulation configuration file using the obtained networking infrastructure information, access key information, ISP information, and router OS information;
consuming the emulation configuration file using ANSIBLE to generate and connect a plurality of virtual devices by applying the routing preference information thereby generating an internet emulation environment;
generating a first virtual connection point for connecting a system under test to the internet emulation environment; and
generating a second virtual connection point for connecting a test device to the internet emulation environment.

2. The computer implemented method of claim 1, wherein generating the internet emulation environment further comprises applying at least one of packet loss metrics and latency metrics to each of a plurality of pathways within the internet emulation environment, each pathway connecting one of the plurality of virtual devices to another of the plurality of virtual devices.

3. The computer implemented method of claim 2, wherein the number of pathways is based on the number of ISPs and a number of routers per ISP.

4. The computer implemented method of claim 1, wherein the emulation configuration file comprises a YAML file.

5. The computer implemented method of claim 1, wherein the virtual devices comprise at least one of virtual machines, virtual machines with a router OS installed, and containers.

6. The computer implemented method of claim 1, wherein the routing protocols comprise at least one of open shortest path first (OSPF), and external border gateway protocol (eBGP).

7. The computer implemented method of claim 1, wherein the first virtual connection point comprising a first endpoint connected to the internet emulation environment.

8. The computer implemented method of claim 1, the second virtual connection point comprising a second endpoint connected to the internet emulation environment.

9. The computer implemented method of claim 1, the emulation size comprising a number of routers per ISP to be emulated.

10. The computer implemented method of claim 1, the infrastructure information comprising at least one of cloud infrastructure, AWS infrastructure, Azure infrastructure, VMware infrastructure, and bare metal infrastructure.

11. The computer implemented method of claim 1, wherein the obtaining networking infrastructure information, access key information, ISP information, and router OS information are performed by obtaining a user provided configuration file.

12. The computer implemented method of claim 11, wherein the user provided configuration file is used to populate the emulation configuration file or is used in place of populating the emulation configuration file.

13. The computer implemented method of claim 1, wherein the router OS comprises at least one of VyOS, JuniperVMX and Cisco.

14. The computer implemented method of claim 1, further comprising providing the emulated internet environment and virtual connection points for use in testing.

15. The computer implemented method of claim 1, further comprising connecting a system under test to the first virtual connection point and connecting a test device to the second virtual connection point.

16. The computer implemented method of claim 1, wherein generating and connecting a plurality of virtual devices by applying the routing preference information comprises installing the at least one router OS on the virtual devices and applying the at least one routing protocol to be used by the virtual devices.

17. A computing system for modeling and emulating network performance and generating a custom virtualization environment, the computing system comprising:
at least one computing processor; and
memory comprising instructions that, when executed by the at least one computing processor, enable the computing system to:
obtain user specified networking infrastructure information for use in an internet emulation environment;
obtain user specified access key information associated with the infrastructure information;
obtain user specified internet service provider (ISP) information to be emulated, the ISP information comprising a total number of ISPs, an emulation size for each ISP, and a region associated with each ISP;
obtain user specified routing preference information, the routing preference information comprising at least one of at least one router operating system (OS) to be emulated and at least one routing protocol to be emulated;
obtain user specified connection points, the connection points associated with a desired testing scenario;
populate an emulation configuration file using the obtained networking infrastructure information, access key information, ISP information, and router OS information;
consume the emulation configuration file using ANSIBLE to generate and connect a plurality of virtual devices by applying the routing preference information thereby generating an internet emulation environment;
generate a first virtual connection point for connecting a system under test to the internet emulation environment; and
generate a second virtual connection point for connecting a test device to the internet emulation environment.

18. A non-transitory computer readable medium comprising instructions that when executed by a processor enable the processor to:
obtain user specified networking infrastructure information for use in an internet emulation environment;
obtain user specified access key information associated with the infrastructure information;
obtain user specified internet service provider (ISP) information to be emulated, the ISP information comprising a total number of ISPs, an emulation size for each ISP, and a region associated with each ISP;
obtain user specified routing preference information, the routing preference information comprising at least one of at least one router operating system (OS) to be emulated and at least one routing protocol to be emulated;
obtain user specified connection points, the connection points associated with a desired testing scenario;
populate an emulation configuration file using the obtained networking infrastructure information, access key information, ISP information, and router OS information;
consume the emulation configuration file using ANSIBLE to generate and connect a plurality of virtual devices by applying the routing preference information thereby generating an internet emulation environment;
generate a first virtual connection point for connecting a system under test to the internet emulation environment; and
generate a second virtual connection point for connecting a test device to the internet emulation environment.
